(19) United States
(12) Patent Application Publication
(10) Pub. No.: US 2008/0155102 A1
(43) Pub. Date: Jun. 26, 2008

(54) METHOD AND SYSTEM FOR MANAGING A COMMUNICATION SESSION

(75) Inventors: Andrew J. Aftelak, Palatine, IL (US); George N. Maracas, Phoenix, AZ (US); Robert A. Zurek, Antioch, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/613,669

(22) Filed: Dec. 20, 2006

(51) Int. Cl. G06F 15/16

(52) U.S. Cl. 709/227

(57) ABSTRACT

A method and system for managing a communication session among a plurality of communication members (116, 118, 120 and 122) is provided. The communication session is managed by an electronic device (102). The method includes identifying (304) an interrupted communication member (120) from the plurality of communication members. The interrupted communication member is talked-over by an interrupting communication member (122) during the communication session. Further, the method includes determining (306) an opportunity to notify in the communication session when the talk-over concludes. Furthermore, the method includes providing (308) a notification of the talk-over to the plurality of communication members during the opportunity to notify.

### FIELD OF THE INVENTION

The present invention generally relates to the field of audio communication, and more particularly, to a method and system for managing a communication session.

### BACKGROUND OF THE INVENTION

The need for establishing audio-conferencing sessions between one or more users at different geographical locations is increasing exponentially today, since the geographical areas in which companies conduct business is expanding continuously. This has resulted in the extensive use of audio conferencing devices in audio-conferencing sessions. Examples of such audio-conferencing devices include, but are not limited to, telephones, computers, Personal Digital Assistants (PDAs), and laptops.

During an audio-conferencing session, each user of the audio-conferencing device used in the session communicates with multiple users of other audio-conferencing devices. These multiple users can be present at different geographical locations. For example, some users participating in the audio-conferencing session may be in Florida, while others may be in Michigan. These users can be connected through a network. Examples of such networks include The Internet and a wireless network. In one scenario, multiple users in an organization can communicate through an enterprise network in an audio-conferencing session.

Sometimes, users may talk simultaneously during an audio-conferencing session. This is known as a talk-over, which results in distortion of messages conveyed by users engaged in the talk-over. This degrades the overall quality of communication in the audio-conferencing session.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary communication network, where various embodiments of the present invention can be practiced;

FIG. 2 is a block diagram of an electronic device, in accordance with an embodiment of the present invention;

FIG. 3 is a flow diagram illustrating a method for managing a communication session among a plurality of communication members, in accordance with an embodiment of the present invention; and

FIG. 4 is a flow diagram illustrating a method for managing a communication session among a plurality of communication members, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION OF THE DRAWINGS

Before describing in detail the embodiments that are in accordance with the present invention, it should be observed that the embodiments reside primarily in combinations of method steps and apparatus components related to managing the communication session. Accordingly, the apparatus components and method steps have been represented where appropriate by conventional symbols in the drawings, showing only those specific details that are pertinent for an understanding of the embodiments of the present invention, so as not to obscure the disclosure with details that will be readily apparent to those with ordinary skill in the art, having the benefit of the description herein.

In this document, the terms comprises,’ ‘comprising,’ or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by ‘comprises . . . a’ does not, without more constraints, preclude the existence of additional identical elements in the process, method, article or apparatus that comprises the element.

In an embodiment, a method for managing a communication session among a plurality of communication members is provided. The communication session is managed by an electronic device. The method includes identifying an interrupted communication member from the plurality of communication members. The interrupted communication member is talked-over by an interrupting communication member during the communication session. Further, the method includes determining an opportunity to notify during the communication session after the talk-over concludes. Furthermore, the method includes providing a notification of the talk-over to the plurality of communication members during the opportunity to notify.

In another embodiment, an electronic device for managing a communication session among a plurality of communication members is provided. The electronic device includes a processor. The processor is configured to identify an interrupted communication member from the plurality of communication members. The interrupted communication member is talked-over by an interrupting communication member during the communication session. The processor is also configured to determine an opportunity to notify during the communication session when the talk-over concludes. Further, the electronic device includes a notification unit that is operatively coupled to the processor. The notification unit is configured to provide a notification of the talk-over to the plurality of communication members during the opportunity to notify.

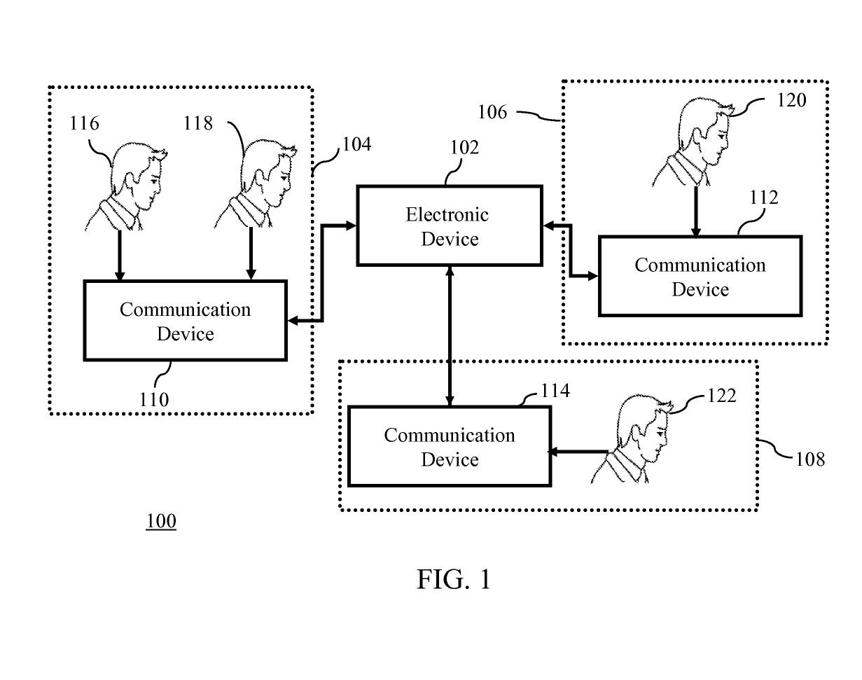

FIG. 1 illustrates an exemplary communication network 100, in accordance with an embodiment of the present invention. The communication network 100 can be a wide area network, a wireless network, an enterprise network, and the like. The communication network 100 includes an electronic device 102. An example of the electronic device 102 can be a centralized server that manages a communication session. The communication network 100 also includes communication territories 104, 106 and 108. Examples of the communication territories 104, 106 and 108 include a conference room, a chamber, and the like. The communication territories 104, 106 and 108 can be located at distinct geographical regions. Although the communication network 100 in FIG. 1 is shown to include the communication territories 104, 106 and 108, it will be apparent to a person ordinarily skilled in the art that the communication network 100 can include one or more communication territories. The communication territory 104 includes a communication device 110. Similarly, the communication territory 106 and the communication territory 108 include a communication device 112 and a communication device 114, respectively. Examples of the communication devices 110, 112 and 114 include, but are not limited to, telephones, personal computers, and audio/video conferencing devices. The communication device 110 is associated with communication members 116 and 118. Similarly, the communication device 112 and the communication device 114 are associated with a communication member 120 and a communication member 122, respectively. It will be apparent to a person ordinary skilled in the art that the communication devices 110, 112 and 114 can be associated with one or more communication members. The communication members 116, 118, 120 and 122 can communicate with each other in the communication session through their respective communication devices 110, 112 and 114. This communication session is managed by the electronic device 102. For example, consider a scenario where the communication member 120 is participating in a conference call in an enterprise network, along with the communication members 116 and 118. In this case, the communication between the communication members 116, 118 and 120 is managed by the electronic device 102. The electronic device 102 manages the communication by ensuring that what a participant, for example, the communication member 120, is saying is heard and understood correctly by the communication members 116 and 118.

The communication devices 110, 112, and 114 can take many forms in the architecture of this invention. Examples of the communication devices 110, 112, and 114 include microphones, microphone arrays, intercom units, networked communication devices such as Plain Old Telephones (POTs), or wireless phones. The communication devices 110, 112, and 114 could also be computer terminals with uplink and downlink audio functionality, or any audio/video pick up devices such as video cameras. Likewise the location of the communication members 116, 118, 120 and 122 can take many forms. The communication members 116, 118, 120 and 122 could all be collocated in the same room with the communication devices 110, 112, and 114 being simple interfaces to the local electronic device 102. The communication members 116, 118, 120 and 122 could also be located in different locations connected via a network with the electronic device 102 being located at one of the communication device locations or configured as a network server device located separately from all of the communication members 116, 118, 120 and 122.

In another scenario, the communication members 116, 118, 120, and 122 start talking simultaneously through their respective communication devices 110, 112 and 114 during the communication session. This simultaneous conversation of the communication members 116, 118, 120, and 122 is known as a talk-over. For example, in the communication session, consider a scenario where the communication member 120 is talking. While the communication member 120 is talking, the communication member 122 interrupts the communication member 120 by starting to talk simultaneously. This results in a talk-over, during which the communication members 116, 118, 120 and 122 cannot fully comprehend or hear clearly the details of the communication. The communication member 120, who is being interrupted, can hereinafter be known as an interrupted communication member 120, and the communication member 122, who is interrupting, can hereinafter be known as an interrupting communication member 122.

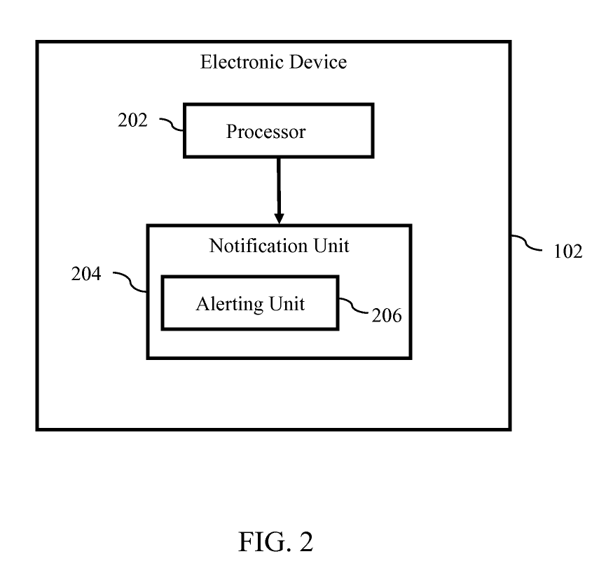

FIG. 2 is a block diagram illustrating the electronic device 102, in accordance with an embodiment of the present invention. The electronic device 102 manages the communication between the communication members 116, 118, 120 and 122. The electronic device 102 includes a processor 202 and a notification unit 204. Those ordinarily skilled in the art will understand that the electronic device 102 may include additional components that are not shown here, since they are not germane to the operation of the electronic device 102, in accordance with the inventive arrangements. To describe the electronic device 102, reference will be made to FIG. 1, although it should be understood that the electronic device 102 can also be implemented in any other suitable environment or network.

The processor 202 is configured to identify the interrupted communication member 120 from the plurality of communication members 116, 118, 120 and 122. The interrupted communication member 120 is a communication member among the plurality of communication members 116, 118, 120 and 122, who has been talked-over by the interrupting communication member 122 during the communication session.

For an embodiment, the processor 202 is configured to identify the interrupted communication member 120 either by means of voice activity detection of a dedicated channel or by voice recognition of a signal from a signal-separated channel. Voice activity detection on as dedicated channel would be used to detect speech for a communication device with a single communication member such as communication device 112 or 114 in FIG. 1. Voice activity detection could be achieved via several methods one of which is described in U.S. Pat. No. 5,619,566 “Voice activity detector for an echo suppressor and an echo suppressor.” The same methods of voice activity detection can be used on signals that are separated from multiple talkers on a single communication device or channel. The separation of individual communication members 116 and 118 interfacing with a single communication device 110 can be achieved through many methods. These methods could include pickups spacially associated with individual communication members, multi-pickup separation methods such as blind source signal separation, or auditory scene analysis of a mixed signal on a single pickup. An example of blind source signal separation is taught in U.S. Pat. No. 5,675,659 “Methods and apparatus for blind source separation of delayed and filtered sources.” Blind source separation or BSS separates the mixed signal from N pickup transducers into the N voices present. In this case the pickup transducers or microphones would be equal to, or greater than the number of communication members associated with a single communication device. Multiple talker separation on a single mixed channel can be achieved via auditory scene analysis an example of which is taught by Bregman in “Auditory Scene Analysis: The Perceptual Organization of Sound.” Another example of auditory scene analysis is US patent application 20060056647 “Separation multiple audio signals recorded as a single mixed signal. Independent of the signal isolation method, identification of multiple interfering talkers can easily be determined via voice activity detection on the independent signals via methods similar to those taught in U.S. Pat. No. 6,415,029 “Echo canceler and double-talk detector for use in a communications unit.” For another embodiment, the processor 202 is configured to identify the interrupted communication member 120 by determining a first portion and a second portion of the communication session. The first portion refers to a time period in the communication session during which the interrupted communication member 120 is the sole talker. The second portion refers to the time period that follows the first portion. In the second portion, it is determined whether any other communication member is talking while the interrupted communication member 120 is talking. The determination of the multiple communications members that are talking would be achieved by the methods detailed above. For example, the first portion of the communication session is determined by the processor 202 in which the interrupted communication member 120 is talking, and a second portion is determined in which any other communication member also starts talking simultaneously with the interrupted communication member 120. For an embodiment, the other communication member who is talking simultaneously is referred to as the interrupting communication member 122. For yet another embodiment, the processor 202 is configured to determine the first portion of the communication session in which the interrupted communication member 120 and at least one other communication member are talking simultaneously after a defined pause of no talking. In addition, the processor 202 can determine the second portion in which the interrupted communication member 120 is the sole talker. The first portion and second portion refer to non-overlapping time sequences, in which the second portion follows the first portion and has the above stated characteristics. For yet another embodiment, the processor 202 is configured to identify the interrupting communication member 122, who has talked-over the interrupted communication member 120.

The processor 202 is configured to determine an opportunity to notify in the communication session when the talk-over concludes. The opportunity to notify is a break in the communication session for a definite time interval when the communication members participating in the communication session stop talking. For an embodiment, the opportunity to notify is defined as the first occurrence of a time interval of a definite duration during which none of the communication members 116, 118, 120 and 122 are talking in the communication session.

The processor 202 is operatively coupled to the notification unit 204. The notification unit 204 is configured to provide a notification of the talk-over to the communication members 116, 118, 120 and 122. The notification unit 204 provides the notification to the communication members 116, 118, 120 and 122 during the opportunity to notify, which is determined by the processor 202. For an embodiment, the notification unit 204 is configured to notify the communication members 116, 118, 120 and 122, to allow the interrupted communication member 120 to talk during the opportunity to notify. In other words, the notification unit 204 can notify the communication members 116, 118, 120 and 122 to allow the interrupted communication member 120 to talk during the opportunity to notify. For another embodiment, the notification unit 204 is configured to notify the communication members 116, 118, 120 and 122 to allow the interrupting communication member 122 to talk during the opportunity to notify. For yet another embodiment, the notification unit 204 includes an alerting unit 206, which is configured to generate an alert to notify the communication members 116, 118, 120 and 122 about the talk-over. The alerting unit 206 can directly communicate with the communication members 116, 118, 120 and 122 via audible or visual means if these communication members 116, 118, 120 and 122 are collocated. The alerting unit 206 can also send the notification to the individual communication devices 110, 112, and 114, which would in turn reproduce the notification for the communication members 116, 118, 120, and 122 at each of the communication devices 110, 112, and 114. The alerting unit 206 is also configured to transmit the alert to the communication members 116, 118, 120 and 122. Examples of types of alerts include, but are not limited to, an audio signal, a text message and a video message. The type of alert can be set by a user of the electronic device 102.

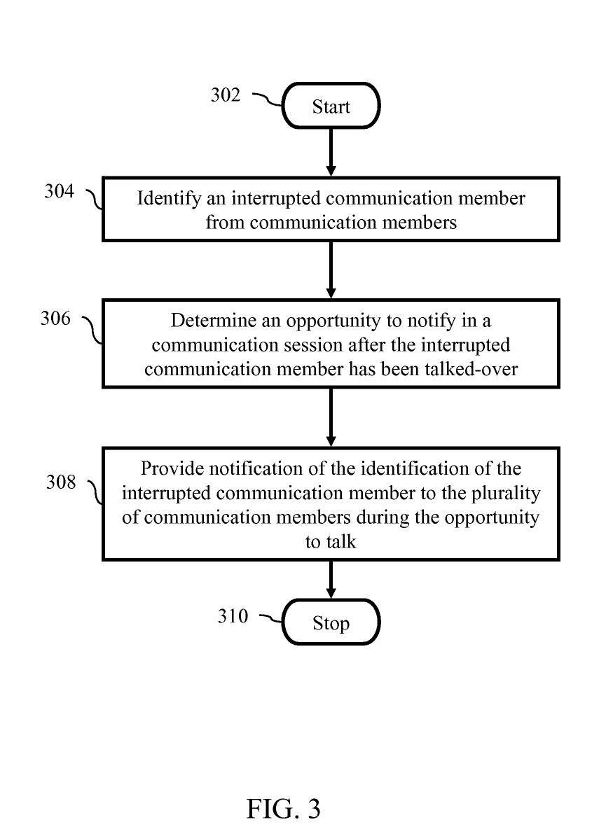

FIG. 3 is a flow diagram illustrating a method for managing the communication session among the communication members 116, 118, 120 and 122, in accordance with an embodiment of the present invention. To describe the flow diagram, reference will be made to FIG. 1 and FIG. 2, although it should be understood that the method can be implemented in any other suitable environment or network. Moreover, the invention is not limited to the order in which the steps are listed in the method.

At step 302, the method for managing the communication session among the communication members 116, 118, 120 and 122 is initiated. The communication session is managed by the electronic device 102. At step 304, an interrupted communication member 120 is identified from the communication members 116, 118, 120 and 122 during the communication session. For example, the interrupted communication member 120, who is talked-over by the interrupting communication member 122, is identified by the electronic device 102. At step 306, an opportunity to notify is determined after the talk-over concludes. For example, when the talk-over involving the interrupted communication member 120 and the interrupting communication member 122 concludes, the electronic device 102 determines an opportunity to notify. In other words, the electronic device 102 determines the time when the communication members involved in the communication session stop talking. At step 308, a notification regarding the talk-over is provided to the communication members 116, 118, 120 and 122 by the electronic device 102 during the opportunity to notify. For an embodiment, the notification is provided by informing the communication members 116, 118, 120 and 122 about the talk-over. In addition, the notification is provided to the communication members 116, 118, 120 and 122 to allow the interrupted communication member 120 and the interrupting communication member 122 to talk during the opportunity to notify. The method is terminated at step 310.

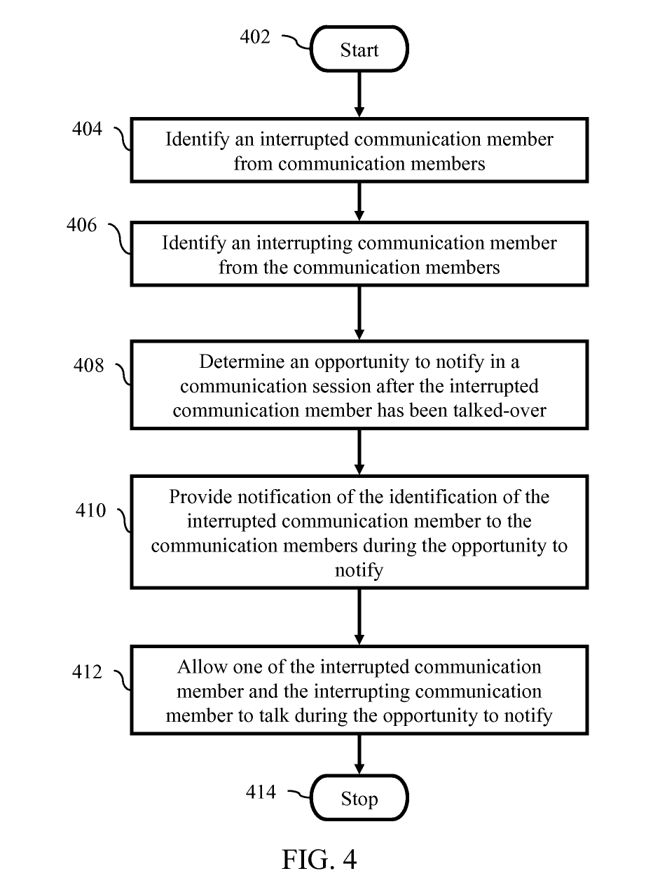

FIG. 4 is a flow diagram illustrating a method for managing the communication session among the communication members 116, 118, 120 and 122, in accordance with an embodiment of the present invention. To describe the flow diagram, reference will be made to FIG. 1, FIG. 2 and FIG. 3, although it should be understood that the method can be implemented in any other suitable environment or network. Moreover, the invention is not limited to the order in which the steps are listed in the method.

At step 402, the method is initiated for managing the communication session among the communication members 116, 118, 120 and 122. The communication session is managed by the electronic device 102. For an embodiment, the communication session can also be managed by any of the communication devices 110, 112, and 114. At step 404, an interrupted communication member 120 is identified from the communication members 116, 118, 120 and 122. The interrupted communication member 120 is talked-over by a communication member from the communication members 116, 118 and 122 during the communication session. For example, the interrupted communication member 120 is identified by the processor 202. For an embodiment, identification of the interrupted communication member 120 by the processor 202 is performed by means of at least the voice activity detection of a dedicated channel or the voice recognition of a signal from a signal-separated channel. For another embodiment, the identification of the interrupted communication member 120 is performed by determining the first portion of the communication session during which the interrupted communication member 120 is the sole talker. The determination of the first portion is followed by the determination of the second portion during which any other communication member from the communication members 116, 118 and 122 is determined to be talking while the interrupted communication member 120 is verified to be talking by the processor 202. For example, the first portion is determined by the processor 202 in which the interrupted communication member 120 is talking. The second portion is also determined by the processor 202 in which the other communication member starts talking simultaneously with the interrupted communication member 120. For an embodiment, the other communication member is referred to as the interrupting communication member 122. For yet another embodiment, the identification is performed by determining the first portion of the communication session during which the interrupted communication member 120 and at least one other communication member among the communication members 116, 118 and 122 talk simultaneously after a defined pause of no talking. Determination of the first portion is followed by the determination of the second portion during which the interrupted communication member 120 is the sole talker. Determination of the first portion and the second portion of the communication session is performed by the processor 202. At step 406, the interrupting communication member 122, who has talked-over the interrupted communication member 120, is identified by the processor 202 of the electronic device 102.

At step 408, an opportunity to notify is determined when the talk-over concludes. For example, when the talk-over between the interrupted communication member 120 and the interrupting communication member 122 concludes, the processor 202 of the electronic device 102 determines an opportunity to notify. In other words, the processor 202 determines the time period when the communication members 116, 118, 120 and 122 stop talking during the communication session. At step 410, a notification pertaining to the talk-over is provided to the communication members 116, 118, 120 and 122 during the opportunity to notify. The notification is provided by the notification unit 204. For an embodiment, providing the notification involves generating an alert for the communication members 116, 118, 120 and 122, based on the talk-over, and then transmitting the alert to the communication members 116, 118, 120 and 122. For example, the alerting unit 206 of the notification unit 204 generates the alert to notify the communication members 116, 118, 120 and 122 regarding the talk-over. The alerting unit 206 transmits the alert to the communication members 116, 118, 120 and 122. At step 412, one of the interrupted communication member 120 and the interrupting communication member 122 is allowed to talk, based on the notification provided to the communication members 116, 118, 120 and 122. The method is terminated at step 414.

As described above, the present invention provides a method and system for managing a communication session. The invention determines a talk-over in the communication session by identifying an interrupted communication member and an interrupting communication member. The invention also provides a notification to the communication members about the talk-over, and then allows a particular communication member to speak. This process of identification and provision of a notification solves the problem of talk-over and results in messages being communicated clearly and comprehensively during the communication session. This invention also allows the communication members to know when their message is not communicated to the other communication members in the communication session. In other words, a communication member, whose speech is been muted by the system, will know that his/her message is not communicated to the other communication members.

It will be appreciated that embodiments of the invention described herein may be comprised of one or more conventional processors and unique stored program instructions that control the one or more processors, to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method for interactivity with broadcast media. Alternatively, some or all the functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented by using a processor and stored program instructions, it will be appreciated that one means for implementing such functions is the media that stores the stored program instructions, be it magnetic storage or a signal conveying a file. Further, it is expected that one with ordinary skill, notwithstanding possibly significant effort and many design choices motivated by, for example, available time, current technology and economic considerations, when guided by the concepts and principles disclosed herein, will be readily capable of generating such stored program instructions and ICs with minimal experimentation.

In the foregoing specification, specific embodiments of the present invention have been described. However, one with ordinary skill in the art would appreciate that various modifications and changes can be made without departing from the scope of the present invention, as set forth in the following claims. Accordingly, the specification and figures are to be regarded in an illustrative rather than a restrictive sense, and all such modifications are intended to be included within the scope of present invention. The benefits, advantages, solutions to problems and any element(s) that may cause any benefit, advantage or solution to occur or become more pronounced are not to be construed as a critical, required or essential features or elements of any or all the claims. The invention is defined solely by the appended claims, including any amendments made during the pendency of this application and all equivalents of those claims, as issued.

The Abstract of the Disclosure is provided to comply with 37 C.F.R. §1.72(b), and requires an Abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment, for the purpose of streamlining the disclosure. This method of disclosure is not to be interpreted as an intention that the claimed embodiments require more features than are expressly recited in each claim. On the contrary, as the following claims reflect, the inventive subject matter is not included in all the features of a single disclosed embodiment. Thus, the following claims are hereby incorporated into the Detailed Description, with each claim standing on its own as a separately claimed subject matter.

What is claimed is:

1. A method for managing a communication session among a plurality of communication members, the communication session being managed by a method performed by an electronic device, the method comprising:
identifying an interrupted communication member from the plurality of communication members, wherein the interrupted communication member is talked-over during the communication session by an interrupting communication member;
determining an opportunity to notify in the communication session after the talk-over concludes; and
providing a notification of the talk-over to the plurality of communication members during the opportunity to talk.

2. The method as recited in claim 1 further comprising identifying which particular communication member is the interrupting communication member.

3. The method as recited in claim 1, wherein identifying the interrupted communication member is performed by at least one of voice activity detection of a dedicated channel and voice recognition of a signal from a signal separated channel.

4. The method as recited in claim 1, wherein identifying comprises:
determining a first portion of the communication session in which the interrupted communication member is a sole talker; and
determining a second portion of the communication session that follows the first portion consecutively in which at least one other communication member is established to be talking while the interrupted communication member is verified to have continued talking.

5. The method as recited in claim 4, wherein the interrupting communication member is established to be talking by at least one of voice activity detection of a dedicated channel and voice activity detection of a signal from a separated signal source.

6. The method as recited in claim 1, wherein identifying comprises:
determining a first portion of the communication session in which the interrupted communication member and at least one other communication member begin talking substantially simultaneously after a defined pause of no talking and the interrupted communication member is identified; and
determining a second portion of the communication session that follows the first portion consecutively in which the interrupted communication member is identified to be a sole talker.

7. The method as recited in claim 6, wherein the interrupting communication member is established to be talking by at least one of voice activity detection of a dedicated channel and voice activity detection of a signal from a separated signal source.

8. The method as recited in claim 1, wherein the opportunity to notify is a break in the communication session for a pre-defined time interval.

9. The method as recited in claim 1, wherein the opportunity to notify is a first occurrence of a defined duration of non-talking audio, after the talk-over is determined.

10. The method as recited in claim 1, wherein providing the notification comprises informing the plurality of communication members to allow the interrupted communication member to talk during the opportunity to notify.

11. The method as recited in claim 1, wherein providing the notification comprises informing the plurality of communication members to allow the interrupting communication member to talk during the opportunity to notify.

12. The method as recited in claim 1, wherein providing the notification further comprises:
generating an alert for the plurality of communication members based on the talk-over; and
transmitting the alert to the plurality of communication members by the electronic device.

13. The method as recited in claim 12, wherein the alert is set based on user preferences associated with the electronic device.

14. The method as recited in claim 12, wherein the alert is one of an audio signal, a text message and a video message.

15. The method as recited in claim 1, wherein the electronic device is a communication device.

16. An electronic device for managing a communication session among a plurality of communication members, the electronic device comprising:
a processor configured to:
identify an interrupted communication member from the plurality of communication members, wherein the interrupted communication member is talked-over during the communication session by an interrupting communication member; and
determine an opportunity to notify in the communication session after the talk-over concludes; and
a notification unit operatively coupled to the processor, wherein the notification unit is configured to provide a notification of talk-over to the plurality of communication members during the opportunity to notify.

17. The electronic device as recited in claim 16, wherein the processor is further configured to identify which particular communication member is the interrupting member.

18. The electronic device as recited in claim 16, wherein the processor is further configured to identify the interrupted communication member by at least one of voice activity detection of a dedicated channel and voice recognition of a signal from a signal separated channel.

19. The electronic device as recited in claim 16, wherein the processor is further configured to:
determine a first portion of the communication session in which the interrupted communication member is a sole talker; and
determine a second portion of the communication session that follows the first portion consecutively in which at least one other communication member is established to be talking while the interrupted communication member is verified to have continued talking.

20. The electronic device as recited in claim 16, wherein the processor is further configured to:
determine a first portion of the communication session in which the interrupted communication member and at least one other communication member begin talking substantially simultaneously after a defined pause of no talking and the interrupted communication member is identified; and
determine a second portion of the communication session that follows the first portion consecutively in which the interrupted communication member is identified to be a sole talker.

21. The electronic device as recited in claim 16, wherein the processor is further configured to establish the interrupting communication member to be talking by at least one of voice activity detection of a dedicated channel and voice activity detection of a signal from a separated signal source.

22. The electronic device as recited in claim 16, wherein the processor is further configured to identify the interrupting communication member that has talked-over the interrupted communication member.

23. The electronic device as recited in claim 16, wherein the notification unit is further configured to notify the communication members to allow the interrupting communication member to talk during the opportunity to notify.

24. The electronic device as recited in claim 16, wherein the notification unit is further configured to notify the communication members to allow the interrupted communication member to talk during the opportunity to notify.

25. The electronic device as recited in claim 16, wherein the notification unit further comprises an alerting unit configured to:
generate an alert for the plurality of communication members based on the talk-over; and
transmit the alert to the plurality of communication members.

26. The electronic device as recited in claim 16, wherein the electronic device is a communication device.
